(19) United States
(12) Patent Application Publication
(10) Pub. No.: US 2011/0221653 A1
(43) Pub. Date: Sep. 15, 2011

(54) META MATERIAL ANTENNA USING COUPLING IN HELICAL STRUCTURE

(76) Inventors: Byung Hoon Ryou, Seoul (KR); Won Mo Sung, Siheung-si (KR); Gi Ho Kim, Anyang-si (KR); Jeong Keun Ji, Seoul (KR)

(21) Appl. No.: 13/129,805

(22) PCT Filed: Nov. 17, 2009
(86) PCT No.: PCT/KR2009/006740

§ 371 Date: May 17, 2011

(30) Foreign Application Priority Data
Nov. 18, 2008 (KR) 1020080114717

(51) Int. Cl. H01Q 1/36

(52) U.S. Cl. 343/895

(57) ABSTRACT

There is provided an antenna implementing a first 0-th order resonant frequency using a first radiator to which power is fed through parallel inductors of helical structures, and implementing a second 0-th order resonant frequency using a second radiator to which power is couple-fed through radiation elements put into the helical structures.

### TECHNICAL FIELD

The present invention relates to a meta material antenna using helical structures and internal coupling power feed, and more specifically, to a meta material antenna implementing a first 0-th order resonant frequency using a first radiator to which power is fed through parallel inductors of the helical structures, and implementing a second 0-th order resonant frequency using a second radiator to which power is couple-fed through radiation elements put into the helical structures.

### BACKGROUND ART

Conventional antennas using a band other than a 0-th order resonant frequency band is largely affected by surrounding and mounting environments.

Generally, in a conventional antenna, a 0-th order resonance is formed at only one frequency, and if two bands are formed, the band is drastically decreased.

### DISCLOSURE OF INVENTION

### Technical Problem

Therefore, the present invention has been made in view of the above problems, and it is an object of the present invention to provide a meta material antenna implementing a first 0-th order resonant frequency using a first radiator to which power is fed through parallel inductors of helical structures, and implementing a second 0-th order resonant frequency using a second radiator to which power is couple-fed through radiation elements put into the helical structures.

### Technical Solution

To accomplish the above object, according to one aspect of the present invention, there is provided a meta material antenna implementing a first 0-th order resonant frequency using a first radiator to which power is fed through parallel inductors of helical structures, and implementing a second 0-th order resonant frequency using a second radiator to which power is couple-fed through radiation elements put into the helical structures.

### Advantageous Effects

According to the present invention, there is provided a meta material antenna implementing a first 0-th order resonant frequency using a first radiator to which power is fed through parallel inductors of helical structures, and implementing a second 0-th order resonant frequency using a second radiator to which power is couple-fed through radiation elements put into the helical structures.

In addition, according to the present invention, there is provided a meta material antenna, in which both of two bands can be least affected by surrounding and mounting environments using two 0-th order resonances.

In addition, according to the present invention, there is provided a meta material antenna, which can solve the bandwidth problem of a 0-th order resonator of a couple power feeding method and minimize interference by using power feeding methods different from each other.

### BRIEF DESCRIPTION OF THE DRAWINGS

FIG. 1 is a view showing the entire structure of an antenna using parallel inductors of helical structures according to an embodiment of the present invention.

FIG. 2 is a view showing an example of a power feeding unit of an antenna according to an embodiment of the present invention.

FIG. 3 is a view showing an example of a first control inductor and a power feeding unit of an antenna according to an embodiment of the present invention.

FIG. 4 is a view showing an example of a first radiator constructing an antenna according to an embodiment of the present invention.

FIG. 5 is a view showing an example of a second radiator constructing an antenna according to an embodiment of the present invention.

### BEST MODE FOR CARRYING OUT THE INVENTION

A meta material antenna using coupling in helical structures will be hereafter described in detail, with reference to the accompanying drawings.

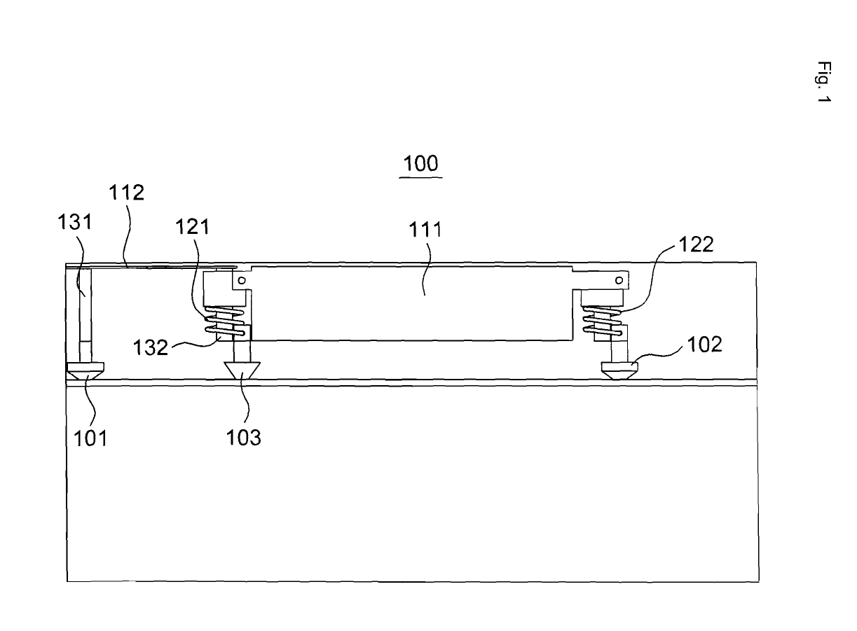

FIG. 1 is a view showing the entire structure of an antenna using parallel inductors of helical structures according to an embodiment of the present invention.

Referring to FIG. 1, the antenna 100 according to an embodiment of the present invention implements a first 0-th order resonant frequency using a first radiator 111 to which power is fed through parallel inductors 101 and 102 of helical structures 121 and 122.

In addition, the antenna 100 according to an embodiment of the present invention implements a second 0-th order resonant frequency using a second radiator 112 to which power is couple-fed through radiation elements put into the helical structures 121 and 122.

In addition, in the antenna 100 according to an embodiment of the present invention, resonant frequency control inductors 101 and 102 are respectively connected to an end of the first and second radiators 111 and 112, and the resonant frequencies can be finely adjusted by changing values of the resonant frequency control inductors.

As described, in the antenna 100 according to an embodiment of the present invention, the resonant frequencies can be adjusted using meta material and coupling power feed.

Accordingly, in the antenna 100 according to an embodiment of the present invention, both of two bands can be least affected by surrounding and mounting environments using two 0-th order resonances.

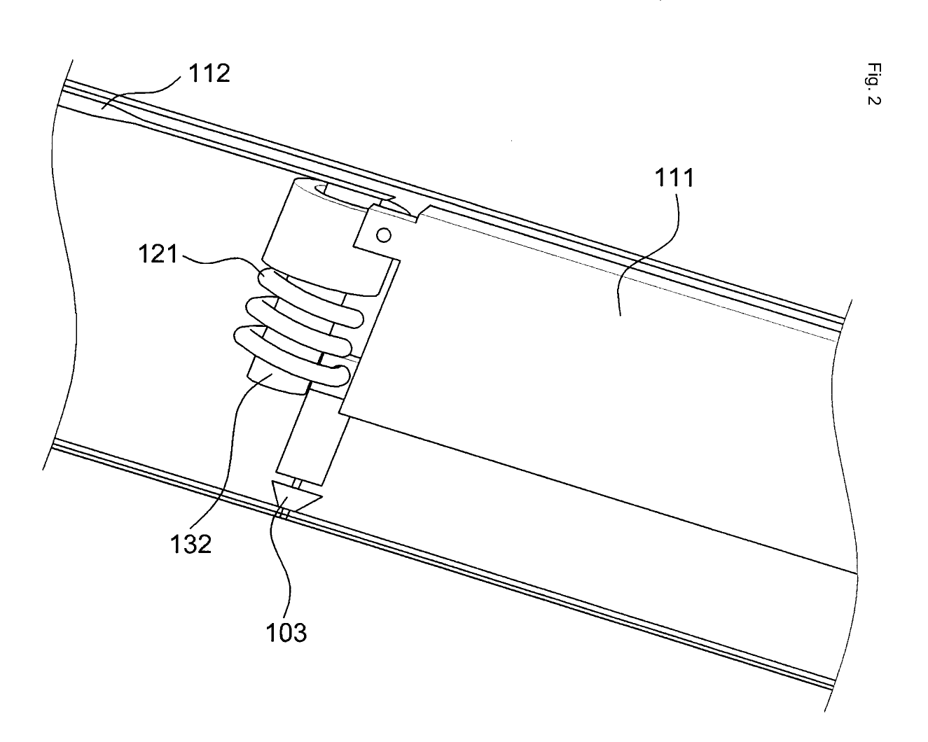

FIG. 2 is a view showing an example of a power feeding unit of an antenna according to an embodiment of the present invention.

Referring to FIGS. 1 and 2, in the antenna 100 according to an embodiment of the present invention, the second radiator 112 is put into the cylinder of the helical structure of the first radiator 111, and power is fed to the second radiator through a power feeding unit 103.

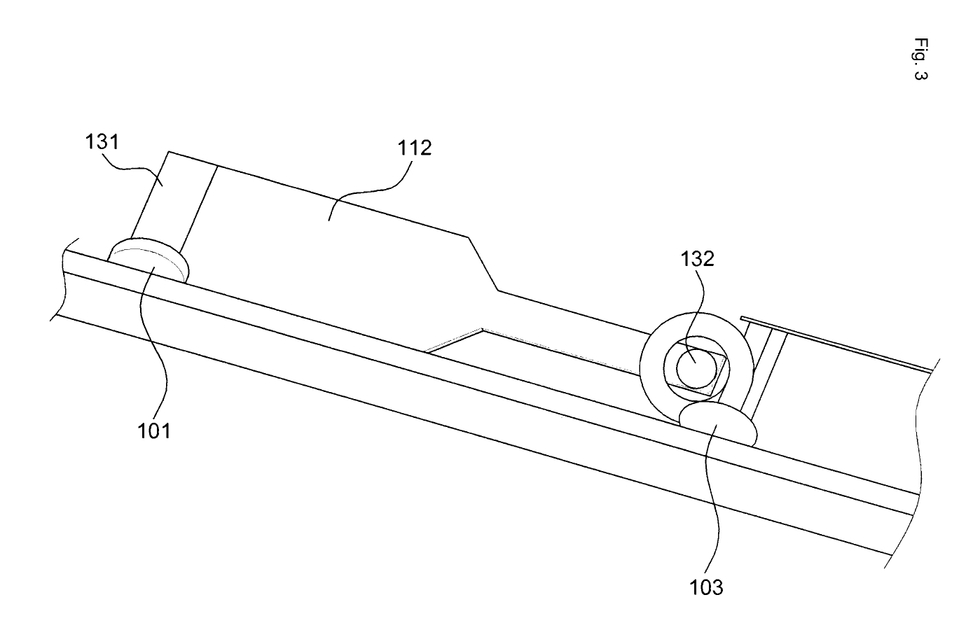

FIG. 3 is a view showing an example of a first control inductor and a power feeding unit of an antenna according to an embodiment of the present invention.

Referring to FIGS. 1 and 3, in the antenna 100 according to an embodiment of the present invention, the first control inductor 101 is connected to the second radiator 112. The second radiator 112 is connected to the power feeding unit 103 through the first helical structure 121.

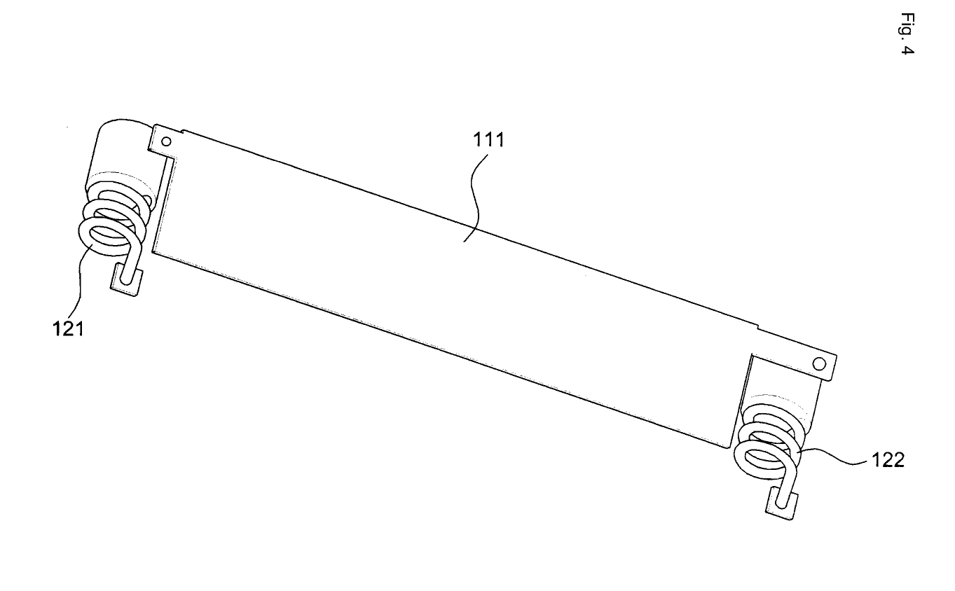

FIG. 4 is a view showing an example of a first radiator constructing an antenna according to an embodiment of the present invention.

Referring to FIGS. 1 and 4, in the antenna 100 according to an embodiment of the present invention, helical structures 121 and 122 are disposed at both ends of the first radiator 111.

In the antenna 100 according to an embodiment of the present invention, if there are two second radiators 112, the second radiators 112 can be respectively put into the cylinders of the helical structures 121 and 122 placed at both ends of the first radiator 111.

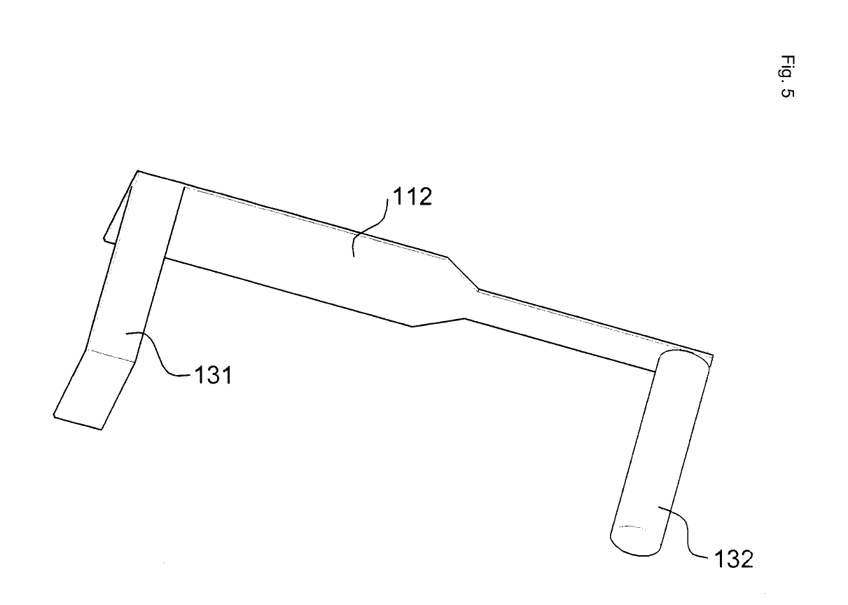

FIG. 5 is a view showing an example of a second radiator constructing an antenna according to an embodiment of the present invention.

Referring to FIGS. 1 and 5, in the antenna 100 according to an embodiment of the present invention, coupling amount is adjusted depending on the length or the thickness of a rod-type metallic member 132 put into the helical structure 121 and 122 or a panel-type metallic member 131.

In addition, in the antenna 100 according to an embodiment of the present invention, impedance of the second resonance can be adjusted depending on the adjusted coupling amount.

Therefore, the antenna 100 according to an embodiment of the present invention can solve the bandwidth problem of a 0-th order resonator of a couple power feeding method and minimize interference by using power feeding methods different from each other.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An antenna implementing a first 0-th order resonant frequency using a first radiator to which power is fed through parallel inductors of helical structures, and implementing a second 0-th order resonant frequency using a second radiator to which power is couple-fed through radiation elements put into the helical structures.

2. The antenna according to claim 1, wherein the second radiator is put into a cylinder of a helical structure of the first radiator.

3. The antenna according to claim 1, wherein if there are two second radiators, the second radiators are respectively put into cylinders of the helical structures placed at both ends of the first radiator.

4. The antenna according to claim 1, wherein coupling amount is adjusted depending on a length or a thickness of a rod-type metallic member put into the helical structure or a panel-type metallic member.

5. The antenna according to claim 4, wherein impedance of the second resonance can be adjusted depending on the adjusted coupling amount.

6. The antenna according to claim 1, wherein inductors are respectively connected to an end of the first and second radiators, and the resonant frequencies are adjusted by changing values of the inductors.

7. The antenna according to claim 1, wherein the resonant frequencies are adjusted using meta material and coupling power feed.
